(19) United States
(12) Patent Application Publication
(10) Pub. No.: US 2005/0019560 A1
(43) Pub. Date: Jan. 27, 2005

(54) Double-sided adhesive tape for applications lncluding in particular the redetachable bonding of flexible CDs to curved surfaces

(75) Inventors: Philippe Hesse, Buchholz (DE); Carsten Bohmer, Pinneberg (DE); Sianty Sunarto, Hamburg (DE); Uwe Schumann, Pinneberg (DE); Nataly Hoppe, Hamburg (DE)

Correspondence Address: NORRIS, MCLAUGHLIN & MARCUS, PA, 875 THIRD STREET, 18TH FLOOR, NEW YORK, NY, 10022, US

(73) Assignee: Tesa Aktiengesellschaft, Hamburg (DE)

(21) Appl. No.: 10/826,965

(22) Filed: Apr. 16, 2004

(30) Foreign Application Priority Data
Apr. 16, 2003 (DE) 103 17 790.6

(51) Int. Cl. B32B 7/12; G03C 8/00

(52) U.S. Cl. 428/355 N; 428/343

(57) ABSTRACT

Disclosed is a double-sided pressure-sensitive adhesive tape having sides which differ in adhesive strength, and a method for its preparation. The double-sided pressure-sensitive adhesive tape comprises at least one adhesive layer comprising a pressure-sensitive adhesive based on a chemically crosslinked polyurethane. The double-sided pressure-sensitive adhesive tape is especially well-suited to adhere flexible storage media, such as CDs, CD-ROMs and DVDs, to curved, bent or creased surfaces. The double-sided pressure-sensitive is also especially well-suited for adhering customer cards and credit cards to paper.

The invention relates to a double-sided pressure-sensitive adhesive tape having sides which differ in adhesive strength, optionally in the form of punched or cut shapes, for the adhesive bonding and also residue-free and damage-free redetachment of flexible storage media of the CD, CD-ROM or DVD type, for example, on planar and in particular also on curved, bent or creased surfaces, substantially without detachment of the flexible storage media particularly in the edge region or marginal region during the period of bonding, where the side to which the flexible storage media are stuck essentially does not feel tacky and/or does not adhere to human skin.

Flexible optical storage media such as those of the CD or CD-ROM type are known, for example, from WO 01/52252 A1. Storage media of this kind consist accordingly in their product structure of a polymeric sheet, typically from the group of the polyesters or polycarbonates, a sol-gel layer applied thereon or alternatively a layer of a photopolymer, optionally a further, metallization layer, and an optional, additional protective varnish layer. In contrast to a conventional CD, the information is read out not through the polymeric sheet but from the opposite side: the either open or, where appropriate, metallized sol-gel layer, alternatively the photopolymer or, if desired, through the protective varnish layer. Consequently this side, referred to below for short as readout side, requires particular protection against mechanical or other damage.

By virtue of their flexibility such storage media are able to conform to the surfaces of many articles of everyday use and/or to their packaging, for example cans, including beverage cans, bottles, pouches, bags, boxes, cartons or crates, and so on, thereby opening up the possibility in principle of transporting them, as information carriers and advertising media, to the target individuals in space-saving fashion and without great effort.

Suitable means of affixing these storage media to the utility articles and/or their packaging include in principle double-sided adhesive tapes or adhesive sheets and also pressure-sensitive adhesives (PSAs) applied without backings as a film to antiadhesive materials (such systems being known as transfer fixatives). The known adhesive articles of the said kind, however, have drawbacks.

The majority of customary double-sided adhesive articles have identical adhesive strength on both sides. The known adhesive articles of this type have the disadvantage either of adhering so strongly to the readout side of the flexible storage medium that the said storage medium cannot be detached from the adhesive article without damaging the readout side or of adhering so weakly to the utility articles or their packaging that secure fixing is not ensured.

Double-sided adhesive articles whose sides have different adhesive strengths are likewise known, for example from DE 43 16 317 A1. As the PSA for the side of the adhesive article to which the readout side of the flexible storage medium is to be stuck it is possible for diverse known systems to be used, all of which, however, are hampered by weaknesses.

PSAs based on natural rubber can be formulated in such a way that they initially have a suitable bond strength and to begin with are also readily redetachable. These PSAs, however, are not stable to ageing. A possible consequence of this after just a short time is the development of highly greasy residues on the storage media or residues which have hardened to a paintlike state.

Polyacrylate-based PSAs, although substantially more stable to ageing, are generally subject to a sharp increase in peel force on the surfaces of the storage media. The term “peel increase” is used by the person skilled in the art to describe the increase in bond strength during storage of the adhesive bond. These PSAs are therefore difficult to redetach and, moreover, generally leave residues on the surfaces. If these PSAs are crosslinked chemically or by radiation it is, admittedly, easier to detach the bonded storage media from them; however, in the case of bonds on curved surfaces there are often instances of unintended detachment of the storage media from the PSA, especially in the edge region or marginal region. Furthermore, both crosslinked and noncrosslinked polyacrylate PSAs lead frequently to irreversible, visually perceptible changes on the surface of the readout side of the storage medium, referred to as deformations. Observations made include the impressions of the adhesive tape in the region of the edges and a gumming of the surface of the readout side of the storage medium, probably caused by the rough PSA surface.

Double-sided adhesive pads in which both PSAs are based on polyurethane and each have a different tack are known from JP 2001 089 720 A1. A drawback is the tangible long-term tack of the pads described, which is a result of the reported bond strength of up to 3.2 N/cm. This results in the utility articles, following the detachment of the adhered storage media, always undesirably sticking to the skin on contact at the points in question.

A double-sided adhesive tape for dirt removal, in which one of the two adhesives is a polyurethane-based PSA which can be removed by washing, is known from JP 06 279 741 A1.

Here again, on the basis of the use described, a tangible long-term tack must be assumed.

It is an object of the present invention, therefore, to provide a double-sided pressure-sensitive adhesive tape with which flexible storage media of the CD, CD-ROM or DVD type, for example, can be adhesively bonded from their readout side to surfaces, including in particular curved, bent or creased surfaces, of articles of everyday use or their packaging, and detached from them again, without the storage media being damaged or having residues left on them, and which no longer exhibits the depicted drawbacks of the prior art, or at least not to the same extent. In particular, there should be no instances of unintended detachment in the edge region or marginal region of the adhesive bonds during the period of bonding, since in that case the readout side of the storage medium would no longer be sufficiently protected against damage by external influences at the points in question. Moreover, following the detachment of storage medium, the adhesive tape should not feel tacky, since that would detract from the quality of the product to which the adhesive tape was bonded.

This object is achieved by means of a double-sided pressure-sensitive adhesive tape, optionally in the form of punched or cut shapes, as described hereinbelow.

The invention accordingly provides a double-sided pressure-sensitive adhesive tape having sides which differ in adhesive strength, comprising at least one adhesive layer, where
the pressure-sensitive adhesive of the adhesive layer is based on a chemically crosslinked polyurethane,
the starting materials of the chemically crosslinked polyurethane include at least one polypropylene glycol having a molar mass of more than 1000 and a functionality of more than 2.0, in a fraction of at least 50% by weight based on the total amount of the isocyanate-reactive substances,
at least 80% of the other isocyanate-reactive starting materials of the chemically crosslinked polyurethane have a molar mass of less than or equal to 1000 and a nominal functionality of 2.0, and
the composition of the starting materials of the chemically crosslinked polyurethane is distinguished by the fact that the ratio of the number of isocyanate groups to the total number of isocyanate-reactive groups is between 0.8 and 1.2, preferably between 0.9 and 1.1, more preferably between 0.95 and 1.05.

The more weakly adhering side of the adhesive tape, in accordance with the invention, essentially does not adhere to human skin or does not feel tacky.

In one preferred embodiment the starting materials of the chemically crosslinked polyurethane include at least one polypropylene glycol having a molar mass of more than 1000 and a functionality of more than 2.0, in a fraction of at least 60% by weight, preferably at least 70% by weight, based on the total amount of the isocyanate-reactive substances.

The invention further provides a double-sided pressure-sensitive adhesive tape having sides which differ in adhesive strength, comprising at least one adhesive layer, where
the pressure-sensitive adhesive of the adhesive layer is based on a chemically crosslinked polyurethane, where the starting materials of the chemically crosslinked polyurethane include at least one polypropylene glycol having a molar mass of less than or equal to 1000 and a functionality of more than 2.0, whose hydroxyl groups have a fraction of at least 50% of the total number of isocyanate-reactive groups,
at least 80% of the other isocyanate-reactive groups of the starting materials of the chemically crosslinked polyurethane are carried by starting materials having a molar mass of more than 1000 and a nominal functionality of 2.0, and
the composition of the starting materials of the chemically crosslinked polyurethane is distinguished by the fact that the ratio of the number of isocyanate groups to the total number of isocyanate-reactive groups is between 0.8 and 1.2, preferably between 0.9 and 1.1, more preferably between 0.95 and 1.05.

In a further preferred embodiment the starting materials of the chemically crosslinked polyurethane include at least one polypropylene glycol having a molar mass of less than or equal to 1000 and a functionality of more than 2.0, whose hydroxyl groups have a fraction of at least 60%, preferably at least 70%, of the total number of isocyanate-reactive groups.

Double-sided adhesive tapes of the invention are composed in one optional embodiment of two adhesive layers: a known PSA layer, which is not restricted in terms of its polymer basis, and applied thereto an inventive PSA layer, based on polyurethane, the last-mentioned layer always having a lower bond strength than the first-mentioned. An unbacked two-layer laminate of this kind comes under the heading of the so-called transfer fixatives, and is produced by applying the PSA layers to an antiadhesive material in web form, and is also dispensed in this form or, optionally, processed further in cutting or punching operations.

In further optional embodiments, adhesive tapes of the invention are composed of three or more layers, namely a backing layer, which may in turn be a laminate of two or more individual layers, and the two different PSA layers applied thereto from either side.

In order to improve the anchorage between the individual layers it is possible to employ all known methods of surface pretreatment, such as, for example, corona pretreatment, flaming or gas-phase treatment (fluorination, for example). It is also possible to use all known methods of priming, in which case the primer layer may be applied either from solution or from dispersion or else in an extrusion or coextrusion process.

Typical overall product thicknesses are from 20 pm to 300 lam, preferably from 30 lam to 200 lam, more preferably from 40 lam to 100 lam, without wishing to restrict the invention with these figures.

As backing layers it is possible to use all known sheets in web form or multi-layer sheet laminates. These sheets or laminates may be either thermoplastic or thermosetting in nature. Examples of preferred backing sheets are those based on PETP, polyamide, PVC or polyolefin, in the latter case especially PE or PP. It is also possible to use elastomer sheets, including thermoplastic elastomer sheets. Examples are sheets based on styrene block copolymers, natural rubber, polyisoprene, polybutadiene, polychloroprene rubber, butyl rubber, silicone rubber, EPDM rubber or ethylene-propylene copolymers, polyurethanes (such as A-3600 (Wolff Walsrode), Platilon UO 1 (Atochem), Desmopan (Bayer) or Elastollan (Elastogran), for example), vinyl copolymers and ethylene-vinyl acetate copolymers. The sheets may include further formulating constituents, such as ageing inhibitors (antioxidants), light stabilizers, UV absorbers, colour pigments, dyes, fillers and other auxiliaries and additives, for example. The backing sheets or individual layers of the backing sheets may further have been foamed with a gas or may have undergone a change in volume resulting from the addition of expandable or ready-expanded microballoons or hollow or solid glass microbeads.

As backing layers it is likewise possible to employ metal foils, wovens, non-wovens, creped or non-creped papers and also laminates of the individual layers and sheets.

The overall thickness of the backing layers employed is typically between 10 and 100 pm, without wishing to restrict the invention with these figures.

The known PSAs described hereinbelow can be used for the more strongly adhering side of the adhesive tape.

The known PSA layer has the function of adhering to surfaces of customary articles of everyday use or to their packaging, such as cans, including beverage cans, bottles, pouches, bags, boxes, cartons or crates, and so on, so effectively that there is no unwanted detachment, or at least no premature unwanted detachment, of the adhesive tape from the utility articles or their packaging. Such a function is fulfilled by a large number of known PSAs or PSA types which differ in their polymer basis. Suitable examples include PSAs based on polyacrylate, natural rubber, styrene block copolymers, ethylene-vinyl acetate copolymers or polyurethane, to name but a few. The PSAs in question can be crosslinked or non-crosslinked. The PSAs can be applied by all known methods, including for example from solution or dispersion, in an extrusion or coextrusion process, by roller application or spray application or in a reactive coating process.

In selecting the PSAs care should be taken to ensure that the adhesive strengths which are attained on the utility articles or their packaging ensure secure fixation. Suitable PSAs include essentially all those whose bond strength, measured indicatively on steel (see Test Methods), is greater than about 1.0 N/cm, preferably greater than 2.0 N/cm, more preferably greater than 3.0 N/cm. In any case, the bond strength of the known PSA which is intended to adhere to the surfaces of customary utility articles and/or their packaging is higher than that of the polyurethane-based PSA to which the readout side of the storage medium is to adhere.

The following polyurethane-based PSAs can be used for the more weakly adhering side of the adhesive tape:
Polyurethane-based PSAs which can be used in accordance with the invention are formed by chemical reaction of at least one at least difunctional polyisocyanate with one or more isocyanate-reactive starting materials, preferably polyols, more preferably polyether-polyols, these starting materials including at least one polypropylene glycol having a molar mass of more than 1000 and having a functionality of more than 2.0, in a fraction of at least 50% by weight, preferably at least 60% by weight, more preferably at least 70% by weight, based on the total amount of the isocyanate-reactive substances, and where at least 80% of the other isocyanate-reactive starting materials have a molar mass of less than or equal to 1000 and a nominal functionality of 2.0. In a further inventive embodiment these starting materials include at least one polypropylene glycol having a molar mass of less than or equal to 1000 and having a functionality of more than 2.0, whose hydroxyl groups have a fraction of at least 50%, preferably at least 60%, more preferably at least 70% of the total number of isocyanate-reactive groups, at least 80% of the other isocyanate-reactive groups being carried by starting materials having a molar mass of more than 1000 and a nominal functionality of 2.0.

The composition of the starting materials of the chemically crosslinked polyurethane is in each case characterized by the fact that the ratio of the number of isocyanate groups to the total number of isocyanate-reactive groups is between 0.8 and 1.2, preferably between 0.9 and 1.1, more preferably between 0.95 and 1.05. In other words the reaction is neither significantly substoichiometric nor significantly superstoichiometric.

In one particular embodiment the polyurethane PSA is substantially stable to light. A PSA of this kind is preferably obtained by using aliphatic or alicyclic diisocyanates. Particularly suitable are aliphatic or alicyclic diisocyanates having an asymmetrical molecular structure, especially isophorone diisocyanate (IPDI).

The bond strength of the polyurethane-based PSA for the more weakly adhering side of the adhesive tape is typically between about 0.01 and 0.4 N/cm, measured on steel (see Test Methods), or between about 0.1 and 0.8 N/cm, preferably between 0.2 and 0.6 N/cm, measured on the readout side of the storage medium (see Test Methods).

Polyisocyanates which can be used include all known polyisocyanates having a functionality of at least 2. These include not only aromatic types such as, for example, the isomers of diphenylmethane diisocyanate (MDI), of diphenyldimethylmethane diisocyanate, of dibenzyl diisocyanate, of phenylene diisocyanate, of tolylene diisocyanate (TDI) or of naphthylene diisocyanate but also all aliphatic or alicyclic types, which are preferred in particular for the preparation of light-stable polyurethanes, such as, for example, butane 1,4-diisocyanate, tetramethoxybutane 1,4-diisocyanate, hexane 1,6diisocyanate, ethylene diisocyanate, dicyclohexylmethane diisocyanate, 1,4diisocyanatocyclohexane, 1,3-diisocyanatocyclohexane, 1,2-diisocyanatocyclohexane, 1,3-diisocyanatocyclopentane, 1,2-diisocyanatocyclopentane, 1,2-diisocyanatocyclobutane, norbornane diisocyanatomethyl, and also chlorinated, brominated, sulphur-containing or phosphorus-containing aromatic, aliphatic or alicyclic diisocyanates, and also derivatives of the diisocyanates listed, especially dimerized or trimerized types, and also types comprising aromatics in which the isocyanate groups are themselves not aromatically attached, such as, for example, the isomers of tetramethylxylylene diisocyanate (TMXDI) or of xylylene diisocyanate.

Aliphatic or alicyclic diisocyanates having in each case an asymmetrical molecular structure, and in which, therefore, the two isocyanate groups each possess a different reactivity, are particularly suitable for producing PSA polyurethanes having the desired profile of properties, particularly in respect of a very substantial avoidance of residues of adhesive on the storage media. By an asymmetrical molecular structure is meant the absence from the molecule of any elements of symmetry (for example mirror planes, axes of symmetry, centres of symmetry); in other words, the impossibility of performing any symmetry operation to produce a molecule congruent with the starting molecule.

Examples of suitable diisocyanates of asymmetrical molecular structure are 2,2,4-trimethylhexamethylene diisocyanate, ethylethylene diisocyanate, 1-methyl-2,4-diisocyanatocyclohexane, 1,6-diisocyanato-2,2,4-trimethylhexane, 1,6-diisocyanato-2,4,4-trimethylhexane, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-1-(4-isocyanatobut-1-yl)-1,3,3-trimethylcyclohexane, 1-isocyanato-2-(3-isocyanatoprop-1-yl)cyclohexane, 1-isocyanato-2-(2-isocyanatoeth-1-yl)cyclohexane or 2-heptyl-3,4-bis(9-isocyanatononyl)-1-pentylcyclohexane. Particular suitability is possessed by 1-isocyanatomethyl-3-isocyanato-1,5,5trimethylcyclohexane (isophorone diisocyanate, IPDI).

As isocyanate-reactive substances it is possible to use all substances which are known for the preparation of polyurethane PSAs, preferably polyols, more preferably polyetherpolyols.

Suitable examples include all polyether-polyols, such as polyethylene glycols, polypropylene glycols, polytetramethylene glycol ethers (polytetrahydrofurans), polyesterpolyols, polycaprolactones, polycarbonates, hydroxyl-functionalized polybutadienes or other polyols containing carbon-carbon double bonds, hydrogenated types of the lastmentioned examples, for example hydrogenated hydroxyl-functionalized polyisoprenes, hydroxylfunctionalized polyisobutylenes or hydroxyl-functionalized polyolefins.

Also suitable are all amino-carrying polyethers which are customary in polyurethane chemistry, since in polyurethane practice the resultant polyureas are counted as polyurethanes (cf. Kunststoff-Handbuch, Vol. 7, Polyurethanes). All of the substances listed can be used with a functionality of 1.0 (monools), 2.0 (diols), 3.0 (triols), with a functionality lying between these values, or with any desired other functionality, or in a mixture.

Besides the isocyanate components listed above and the components which react with them, however, it is also possible to use other starting materials to form the polyurethane without departing from the concept of the invention.

As polypropylene glycols it is possible to use all commercially customary polyethers based on propylene oxide and a starter which is difunctional in the case of the diols and trifunctional in the case of the triols. Included here are not only the polypropylene glycols prepared conventionally —that is, generally, using a basic catalyst, such as potassium hydroxide, for example—but also the particularly pure polypropylene glycols prepared by DMC (double metal cyanide) catalysis, whose preparation is described in, for example, U.S. Pat. No. 5,712,216 A, U.S. Pat. No. 5,693,584 A, WO 99/56874 A1, WO 99/51661 A1, WO 99/59719 A1, WO 99/64152 A1, U.S. Pat. No. 5,952,261 A1, WO 99/64493 A1 and WO 99/51657 A1. A characteristic of the DMC-catalysed polypropylene glycols is that the “nominal” or theoretical functionality of precisely 2.0 in the case of the diols or precisely 3.0 in the case of the triols is also actually achieved approximately. In the case of the conventionally prepared polypropylene glycols the “true” functionality is always somewhat lower than the nominal functionality, particularly in the case of polypropylene glycols having a relatively high molecular weight. One of the reasons for this is a secondary reaction of rearrangement of the propylene oxide to form allyl alcohol.

It is additionally possible to use all polypropylene glycol diols or triols which contain copolymerized ethylene oxide, which is the case in many commercially customary polypropylene glycols, in order to obtain an increased reactivity towards isocyanates.

By varying the ratio of the number of hydroxyl groups in the diol to that in the triol it is possible to adjust the bond strength in accordance with the application. Surprisingly it has been found that the higher the ratio of the number of diol OH groups to the number of triol OH groups the greater the bond strength.

The bond strength may further be adjusted by way of the ratio of the number of isocyanate groups to the total number of hydroxyl groups. The tendency is for the bond strength to increase the greater this ratio deviates from 1 towards smaller values.

In one possible embodiment the polyurethane-based PSA includes further formulating ingredients such as, for example, catalysts, ageing inhibitors (primary and secondary antioxidants), light stabilizers such as, for example, UV absorbers, rheological additives, colour pigments, dyes, and other auxiliaries and additives.

In the selection of these substances it should be ensured, with a view to residue-free detachability, that these substances do not have any tendency to migrate to the substrate to be bonded, so that there are no attendant residues or else instances of discoloration. For the same reason the concentration of these substances, particularly the liquid substances, in the composition as a whole is to be kept as low as possible. The additional use of plasticizers or tackifier resins should therefore be avoided, without there being any intention thereby to exclude these substances entirely.

In order to accelerate the reaction between the isocyanate component and the isocyanate-reactive component it is possible to use all of the catalysts known to the person skilled in the art, such as tertiary amines, organobismuth compounds or organotin compounds, for example, to name but a few.

The selection of the catalyst and also its concentration are additional ways in which the bond strength can be influenced and adjusted in accordance with what is required. The tendency is for the bond strength to decrease as the activity of the catalyst rises.

The use of antioxidants, though advantageous, is not mandatory.

The suitable antioxidants include, for example, sterically hindered phenols, hydroquinone derivatives, sterically hindered amines, organic sulphur compounds and organic phosphorus compounds.

Light stabilizers, such as UV absorbers, can also optionally be used.

Light stabilizers used are those disclosed in Gaechter and Mailer, Taschenbuch der Kunststoff-Additive, Munich 1979, in Kirk-Othmer (3rd) 23, 615-627, in Encycl. Polym. Sci. Technol. 14, 125-148 and in Ullmann (4th) 8, 21; 15, 529, 676.

Examples of rheological additives are pyrogenic silicas, phyllosilicates (for example bentonites), high molecular mass polyamide powders or castor oil derivative powders.

Substances suitable for the colouring of the PSA include all known colour pigments and/or dyes which can be used in polyurethane chemistry.

In one preferred embodiment the pressure-sensitive adhesive is prepared continuously and applied in web form, in accordance with the process described below:
A vessel A is charged substantially with the premixed, isocyanate-reactive substances (“polyol component”) and a vessel B is charged substantially with the isocyanate component, it being possible where appropriate for the further formulating ingredients to have been mixed into these components beforehand in a standard mixing procedure.

The polyol component and the isocyanate component are conveyed via precision pumps through the mixing head or mixing tube of a multi-component mixing and metering unit, where they are homogeneously mixed and so brought to reaction. The chemically interreactive compounds mixed in this way are applied immediately thereafter to a backing material in web form, which is preferably moving at a constant speed. The nature of the web-form backing material depends on the precise product structure of the double-sided pressure-sensitive adhesive tape and also on the judiciousness of the manufacturing operation. For example, especially for the case of a two-layer, unbacked product construction, it can be an antiadhesive material in web form which is optionally already precoated with a known PSA, in which case, in this option, the mixed, chemically interreacting, initially still-liquid polyurethane components can be coated directly onto the known PSA.

In particular for the case of a three-layer or multi-layer product construction with integrated backing layer, it can be this backing itself, which optionally can be already precoated from the opposite side with the known PSA. The polyurethane PSA coated onto a backing material in web form can optionally also be laminated together with the other components of the adhesive tape in a subsequent machining step.

The backing material coated with the reactive polyurethane composition is passed through a heating tunnel in which the polyurethane composition cures to the PSA. The coatweight of the polyurethane composition is freely selectable. It is guided by the detailed product properties to be set; the typical product thicknesses set out above should preferably be observed. Finally, the coated backing material is wound up in a winding station.

The process described allows solvent-free and water-free operation. Solvent-free and water-free operation is the preferred procedure, but is not mandatory. In order, for example, to obtain particularly low coatweights, the components can be diluted appropriately. In order to enhance the anchorage of the polyurethane composition on the backing material or on the known PSA it is possible to use all known methods of surface pretreatment, such as corona pretreatment, flaming, or gas-phase treatment (fluorination, for example). It is likewise possible to use all known methods of priming, in which case the primer layer can be applied either from solution or dispersion or else in an extrusion or coextrusion process.

With their more strongly adhering side, adhesive tapes of the invention have bond strengths on steel (see Test Methods), determined at a peel angle of 180°, of more than about 1.0 N/cm, preferably more than 2.0 N/cm, more preferably more than 3.0 N/cm. The more strongly adhering side adheres to the surfaces of customary articles of everyday use and/or to their packaging, such as cans, including beverage cans, bottles, pouches, bags, boxes, cartons or crates, and so on, so well that in normal use there is no unwanted detachment, or at least no premature unwanted detachment, of the adhesive tape from the utility articles or their packaging. With the more weakly adhering, polyurethane-based side of the adhesive tape, bond strengths on steel (see Test Methods), determined at a peel angle of 180°, of between about 0.01 and 0.4 N/cm are typically achieved. The bond strengths of this side on the readout side of the storage medium (see Test Methods), determined at a peel angle of 180°, are typically between about 0.1 and 0.8 N/cm, preferably between 0.2 and 0.6 N/cm.

With adhesive tapes of the invention it is possible to bond flexible CDs, CD-ROMs or other storage media of the type described to cylindrical bodies having typical diameters of at least greater than or equal to about 5 cm for periods of at least 3 months without any instances of spontaneous detachment, particularly not in the marginal region or edge region of the bent (and therefore under stress) CDs or CD-ROMs.

Storage media can be detached by hand from the adhesive tapes of the invention in each case without damage. Surprisingly it has been found that the pressure-sensitive adhesive exposed after the storage media have been detached, despite the very good adhesion properties to storage media, sticks neither to the skin nor to paper and/or does not feel sticky. The storage media, following their detachment from the adhesive tape of the invention, have no deformations, spots or residues detrimental to the quality of the storage media, or at least none which are visible.

As well as for the adhesive bonding and also residue-free and damage-free redetachment of flexible storage media, such as those of the CD, CD-ROM or DVD type on curved, bent or creased surfaces, for example, double-sided pressure-sensitive adhesive tapes of the invention having sides which differ in adhesive strength are also suitable for diverse other utilities. For example, they can be used to bond both flexible and non-flexible storage media to planar or substantially planar surfaces, such as in books, magazines, brochures and the like, for example. Furthermore, adhesive tapes of the invention are suitable for the adhesive bonding (redetachably without residue or damage) of customer cards, credit cards or the like to personal letters for sending out the cards. Adhesive tapes of the invention are generally suitable for fixing lightweight articles, particularly those with surfaces of plastic, metal or glass, in such a way that they can be redetached without residue or damage.

The following test methods were used briefly to characterize the specimens produced in accordance with the processes described.

Bond Strength (180° Peel Angle)

The bond strength was tested in accordance with PSTC-101. According to this method the adhesive tapes of the invention with a width of 10 mm are applied to different substrates (steel, the readout side of a flexible CD (in this case a modified epoxy protective varnish), the backing side of a flexible CD (in this case PETP), paper (in this case commercially customary paper for copiers)) and then peeled off under defined conditions by means of a tensile testing machine.

The peel angle is in each case 180° and the separation speed 300 mm/min. The figure reported is the average value for the peel force in the region in which the adhesive tape has detached from the substrate by between 10 mm and 40 mm. The force required for peeling is the bond strength, which is reported with the units N/cm. The more weakly adhering side of the adhesive tape was tested in each case on the substrates indicated. The more strongly adhering side, whose PSA is known, was tested only on steel.

The steel substrate is specified as follows:
stainless steel, V2A (16/6), material No. 1.4301 according to DIN 17440, polished, arithmetic mean roughness 0.05 to 0.2 μm.

Long-Term Bond Strength on Cylindrical Bodies

To determine the long-term bond strength and detachment characteristics on curved surfaces, adhesive tapes of the invention are bonded with their more strongly adhering side to a steel cylinder (radius: 2.5 cm). Then flexible CDs (thickness: approximately 125 μm, diameter: approximately 9.0 cm; surface 1 (backing layer of the CD): polyester; surface 2 (readout side of the CD): modified epoxy varnish) are bonded both with the readout side and, in a second test, with the backing side to the more weakly adhering side of the adhesive tape. The adhesive bonds are assessed for detachment of the CDs from the adhesive tape, especially in the edge region, after 3 months of storage at room temperature (23° C.), at +50° C. and after storage with temperature cycling (4 cycles each of 1 week at −10° C., 1 week at room temperature, and 1 week at +50° C.). The result is reported as the radial detachment distance in mm units.

The CDs are then deliberately detached by hand at room temperature and examined and evaluated for residues originating from the PSA (for example shadows, coverings, spots) and for deformation or other damage. The readability of the data is tested subsequently.

The adhesion of the PSA layer exposed following the detachment of the CDs to the skin is determined in sensory testing.

The intention of the text below is to illustrate the invention with reference to examples, though without wishing thereby to restrict it.

### EXAMPLES

The following backing sheets and backing materials are used in the examples:
commercial polyester film (PETP)
thickness: 12 lam, width: 50 cm, manufacturer: Mitsubishi
commercial BOPP film
thickness: 28 lam, width: 50 cm, manufacturer: Radici
silicone base paper AV 100 NF
thickness: 70 dam, width: 50 cm, manufacturer: Ahlstrom
extrudate of Elvax 310® (EVA-based elastomer, manufacturer: DuPont)
thickness of extrudate: 50 lam, width: 50 cm.

The following known adhesives are used for the more strongly adhering side of the adhesive tape of the invention in the examples:

Known PSA 1:

(Acrylate Copolymer-Based Type)

A 2 I reactor conventional for free-radical polymerizations is charged with
20 g hydroxypropyl acrylate
60 g methyl acrylate
210 g ethylhexyl acrylate
210 g butyl acrylate
300 g acetone/special boiling point spirit 60/95 (1:1).

After nitrogen gas has been passed through the reactor with stirring for 45 minutes the reactor is heated to 58° C. and 0.2 g azoisobutyronitrile (AIBN) is added. Subsequently the external heating bath is heated to 75° C. and the reaction is conducted constantly at this temperature.

After a reaction time of 1 h a further 0.2 g AIBN is added.

After 2.5 h and 5 h dilution is carried out in each case with 150 g of acetone/special boiling point spirit 60/95 (1:1).

The reaction is terminated after a reaction time of 48 h and the reaction mixture is cooled to room temperature.

Finally, based on the quantitative ratios above, 2.5 g Desmodur Z® are added. The PSA is hence ready for coating.

Known PSA 2:

(Natural Rubber-Based Type)

A PSA of the following composition which is prepared by conventional methods in a compounder is used:

| Weight | | | |
|---|---|---|---|
| fraction (% | | | |
| by wt.) | Trade name | Chemical basis | Manufacturer/supplier |
| 46.0 | Natural rubber SMR CV50 ® | Natural rubber | Weber & Schaer |
| 26.0 | Zonarez B 115 S ® | Poly-pinene resin | Arizona |
| 10.0 | Dertophene T 110 ® | Terpene-phenolic | DRT |
| | | resin | |
| 7.0 | Resin 731 D ® | Rosin | Abieta |
| 7.0 | Nipol 1312 LV ® | Acrylonitrile- | Zeon |
| | | butadiene copolymer | |
| 3.0 | Zinc oxide Weiβsiegel ® | Zinc oxide | Grillo |
| 1.0 | Irganox 1010 ® | Sterically hindered | Ciba-Geigy |
| | | phenol | |

The PSA is prepared and used at a concentration of 20% in petroleum spirit/ethanol (100:5).

Known PSA 3:

(Styrene Block Copolymer-Based Type)

A PSA of the following composition prepared by conventional methods in a compounder is used in solvent-free form:

| Weight | | | |
|---|---|---|---|
| fraction (% | | | |
| by wt.) | Trade name | Chemical basis | Manufacturer/supplier |
| 45.0 | Vector 4113 ® | Styrene-isoprene-styrene block | Exxon Mobil |
| | | copolymer | |
| 45.0 | Escorez 2203 ® | Aromatic-modified | Exxon Mobil |
| | | C-5 hydrocarbon resin | |
| 9.0 | Ondina G41 ® | White oil | Shell Chemicals |
| 1.0 | Irganox 1010 ® | Sterically hindered phenol | Ciba-Geigy |

The following raw materials are used for preparing the polyurethane PSAs for the more weakly adhering side of adhesive tapes of the invention in the examples. The raw materials stated are all freely available commercially.

| | Chemical basis | |
|---|---|---|
| | Average molar mass | Manufacturer/ |
| Trade name | OH or NCO number | supplier |
| Desmophen 1262 BD ® | Polypropylene glycol, | Bayer |
| | Diol (M = 430) | |
| | (4661 mmol OH/kg) | |
| Acclaim 4220 N ® | Polypropylene glycol, | Bayer |
| | Diol, high-purity, | |
| | prepared with DMC | |
| | catalysis (M = 4000) | |
| | (500 mmol OH/kg) | |
| Desmophen 1380 BT ® | Polypropylene glycol, | Bayer |
| | Triol (M = 450) | |
| | (6774 mmol OH/kg) | |
| Acclaim 6320 N ® | Polypropylene glycol, | Bayer |
| | Triol, high-purity, | |
| | prepared with DMC | |
| | catalysis (M = 6000) | |
| | (500 mmol OH/kg) | |
| Vestanat IPDI ® | Isophorone diisocyanate | Degussa-Huls |
| | (M = 222.3) | |
| | (8998 mmol NCO/kg) | |
| Desmodur W ® | Dicyclohexylmethane | Bayer |
| | diisocyanate | |
| | (M = 262) | |
| | (7571 mmol NCO/kg) | |
| Mark DBTL ® | Dibutyltin dilaurate | Nordmann, |
| | | Rassmann |
| | Bismuth | |
| | trisneodecanoate | |
| | CAS No. 34364-26-6 | |
| Tinuvin 292 ® | Sterically hindered | Ciba |
| | amine, light stabilizer | |
| Tinuvin 400 ® | Triazine derivative, | Ciba |
| | UV protectant | |

Coatings of polyurethane in the examples were carried out on a standard laboratory coating unit for continuous coating. The sheet width was 50 cm. The coating slot width was variably adjustable between 0 and 1 cm. The length of the heating tunnel was about 12 m. The temperature in the heating tunnel was divisible into four zones each freely selectable between room tempreature and 120° C.

A standard multi-component mixing and metering unit with a dynamic mixing system was used.

The mixing head was designed for two liquid components. The mixing rotor had a variable speed of up to approximately 5000 rpm max. The metering pumps of this unit were gear pumps having an output of approximately 21/min max.

The polyol components and the components with the isocyanate-reactive substances were prepared in a standard heatable and evacuable mixing tank. During the mixing operation, which took about two hours in each case, the temperature of the mixture was set at about 70° C. and a vacuum was applied in order to degas the components.

### Examples 1 to 3

The PETP backing sheet is first coated conventionally with the known PSAs 1 (Example 1), 2 (Example 2) and 3 (Example 3) and, after the solvent in each case (Examples 1 and 2) has evaporated, the adhesive-coated sheets are rolled up in the heating tunnel and at the same time laminated with standard siliconized release paper. The coatweight is in each case 30 g/m². The PETP sheet precoated in this way is subsequently coated from the opposite side with a polyurethane PSA of the following composition by the method described above, in a coatweight of 30 g/m²:
NCO/OH ratio: 1.05

Ratio of number of diol OH/number of triol OH: 2.3

| | | | Number of OH |
|---|---|---|---|
| | | | or NCO groups, |
| | | Weight | based |
| | | fraction | on the percentage |
| | Raw material | [% by wt.] | weight fraction |
| A component | Desmophen 1262 BD ® | 17.1 | 79.7 mmol OH |
| | Acclaim 6320N ® | 68.3 | 34.2 mmol OH |
| | Bismuth | 1.0 | |
| | trisneodecanoate | | |
| | Tinuvin 292 ® | 0.1 | |
| | Tinuvin 400 ® | 0.2 | |
| B component | Vestanat IPDI ® | 13.3 | 119.7 mmol NCO |

### Characteristic Test Results

more strongly adhering side (known PSA):
bond strength on steel: >3.0 N/cm
more weakly adhering side (polyurethane PSA):
bond strength on steel: 0.1 N/cm
bond strength on the readout side of the CD: 0.4 N/cm
bond strength on the backing side of the CD: 0.2 N/cm
bond strength on paper: <0.1 N/cm
long-term bond strength on cylindrical bodies:
after 3 months' storage at room temperature: detachment distance<1 mm
after 3 months' storage at +50° C.: detachment distance<1 mm
after 3 months' storage with temperature cycling: detachment distance<1 mm
residues, deformations, damage: not visible
data readability: yes
adhesion to skin: no adhesion

### Examples 4 to 6

The BOPP backing sheet is first corona-pretreated on both sides and then coated conventionally with the known PSAs 1 (Example 4), 2 (Example 5) and 3 (Example 6) and, after the solvent in each case (Examples 4 and 5) has evaporated, the adhesivecoated sheets are rolled up in the heating tunnel and at the same time laminated with standard siliconized release paper. The coatweight is in each case 30 g/m². The BOPP sheet precoated in this way is subsequently coated from the opposite side with a polyurethane PSA of the following composition by the method described above, in a coatweight of 30 g/m²:
NCO/OH ratio: 1.02

Ratio of number of diol OH/number of triol OH: 1.3

| | | | Number of OH |
|---|---|---|---|
| | | | or NCO |
| | | Weight | groups based |
| | | fraction | on the percentage |
| | Raw material | [% by wt.] | weight fraction |
| A component | Desmophen 1262 BD ® | 10.8 | 50.7 mmol OH |
| | Acclaim 6320N ® | 78.0 | 39.0 mmol OH |
| | Bismuth trisneodecanoate | 1.0 | |
| B component | Vestanat IPDI ® | 10.2 | 91.4 mmol NCO |

### Characteristic Test Results

more strongly adhering side (known PSA):
bond strength on steel: >3.0 N/cm
more weakly adhering side (polyurethane PSA):
bond strength on steel: 0.2 N/cm
bond strength on the readout side of the CD: 0.3 N/cm
bond strength on the backing side of the CD: 0.2 N/cm
bond strength on paper: <0.1 N/cm
long-term bond strength on cylindrical bodies:
after 3 months' storage at room temperature: detachment distance<1 mm
after 3 months' storage at +50° C.: detachment distance<1 mm
after 3 months' storage with temperature cycling: detachment distance<1 mm
residues, deformations, damage: not visible
data readability: Yes
adhesion to skin: no adhesion

### Examples 7 to 9

The silicone base paper (i.e. paper without silicone coating) is first coated conventionally with the known PSAs 1 (Example 7), 2 (Example 8) and 3 (Example 9) and, after the solvent in each case (Examples 7 and 8) has evaporated, the adhesive-coated sheets are rolled up in the heating tunnel and at the same time laminated with standard siliconized release paper. The coatweight is in each case 50 g/m². The paper precoated in this way is subsequently coated from the opposite side with a polyurethane PSA of the following composition by the method described above, in a coatweight of 30 g/m²:
NCO/OH ratio: 1.0

Ratio of number of diol OH/number of trio) OH: 0.2

| | | | Number of |
|---|---|---|---|
| | | | OH or NCO |
| | | Weight | groups based |
| | | fraction | on the percentage |
| | Raw materials | [% by wt.] | weight fraction |
| A component | Acclaim 4220 N ® | 58.0 | 29.0 mmol OH |
| | Desmophen 1380 BT ® | 21.5 | 145.2 mmol OH |
| | Mark DBTL ® | 1.0 | |
| B component | Vestanat IPDI ® | 19.5 | 174.2 mmol NCO |

### Characteristic Test Results

more strongly adhering side (known PSA):
bond strength on steel: >3.0 N/cm
more weakly adhering side (polyurethane PSA):
bond strength on steel: 0.2 N/cm
bond strength on the readout side of the CD: 0.4 N/cm
bond strength on the backing side of the CD: 0.3 N/cm
bond strength on paper: <0.1 N/cm
long-term bond strength on cylindrical bodies:
after 3 months' storage at room temperature: detachment distance<1 mm
after 3 months' storage at +50° C.: detachment distance<1 mm
after 3 months' storage with temperature cycling: detachment distance<1 mm
residues, deformations, damage: not visible
data readability: yes
adhesion to skin: no adhesion

### Examples 10 to 12

The elastic Elvax 310 extrudate, which is present on a standard siliconized release paper, is first coated conventionally with the known PSAs 1 (Example 10), 2 (Example 11) and 3 (Example 12) and, after the solvent in each case (Examples 10 and 11) has evaporated, the adhesive-coated sheets are rolled up in the heating tunnel and at the same time laminated with standard siliconized release paper. The coatweight is in each case 50 g/m². The extrudate precoated in this way is subsequently coated from the opposite side with a polyurethane PSA of the following composition by the method described above, in a coatweight of 30 g/m²:
NCO/OH ratio: 1.0

Ratio of number of diol OH/number of triol OH: 1.5

| | | | Number of |
|---|---|---|---|
| | | | OH or NCO |
| | | Weight | groups based |
| | | fraction | on the percentage |
| | Raw material | [% by wt.] | weight fraction |
| A component | Desmophen 1262 BD ® | 12.0 | 56.0 mmol OH |
| | Acclaim 6320 N ® | 74.7 | 37.3 mmol OH |
| | Mark DBTL ® | 1.0 | |
| B component | Desmodur W ® | 12.3 | 93.3 mmol NCO |

### Characteristic Test Results

more strongly adhering side (known PSA):
bond strength on steel: >3.0 N/cm
more weakly adhering side (polyurethane PSA):
bond strength on steel: 0.1 N/cm
bond strength on the readout side of the CD: 0.2 N/cm
bond strength on the backing side of the CD: 0.1 N/cm
bond strength on paper: <0.1 N/cm
long-term bond strength on cylindrical bodies:
after 3 months' storage at room temperature: detachment distance, <1 mm
after 3 months' storage at +50° C.: detachment distance<1 mm
after 3 months' storage with temperature cycling: detachment distance<1 mm
residues, deformations, damage: not visible
data readability: yes
adhesion to skin: no adhesion

### Examples 13 to 15

A standard, double-sided siliconized release paper, is first coated conventionally with the known PSAs 1 (Example 13), 2 (Example 14) and 3 (Example 15) and, after the solvent in each case (Examples 13 and 14) has evaporated, the adhesive-coated sheets are rolled up in the heating tunnel. The coatweight is in each case 50 g/m². The known PSAs thus present in coated form are then each coated directly with a polyurethane PSA of the following composition by the method described above, in a coatweight of 30 g/m²:
NCO/OH ratio: 1.05

Ratio of number of diol OH/number of triol OH: 2.3

| | | | Number of |
|---|---|---|---|
| | | | OH or NCO |
| | | Weight | groups based |
| | | fraction | on the percentage |
| | Raw materials | [% by wt.] | weight fraction |
| A component | Desmophen 1262 BD ® | 17.1 | 79.7 mmol OH |
| | Acclaim 6320N ® | 68.3 | 34.2 mmol OH |
| | Bismuth trisneodecanoate | 1.0 | |
| | Tinuvin 292 ® | 0.1 | |
| | Tinuvin 400 ® | 0.2 | |
| B component | Vestanat IPDI ® | 13.3 | 119.7 mmol NCO |

### Characteristic Test Results

more strongly adhering side (known PSA):
bond strength on steel: >3.0 N/cm
more weakly adhering side (polyurethane PSA):
bond strength on steel: 0.2 N/cm
bond strength on the readout side of the CD: 0.5 N/cm
bond strength on the backing side of the CD: 0.3 N/cm
bond strength on paper: <0.1 N/cm
long-term bond strength on cylindrical bodies:
after 3 months' storage at room temperature: detachment distance<1 mm
after 3 months' storage at +50° C.: detachment distance<1 mm
after 3 months' storage with temperature cycling: detachment distance<1 mm
residues, deformations, damage: not visible
data readability: yes
adhesion to skin: no adhesion

It should be understood that the preceding is merely a detailed description of one preferred embodiment or of a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

1. A double-sided pressure-sensitive adhesive tape comprising first and second sides which differ in adhesive strength, said first side comprising at least one adhesive layer comprising a pressure-sensitive adhesive based on a chemically crosslinked polyurethane, where the chemically crosslinked polyurethane is formed from starting materials comprising at least one polypropylene glycol having a molar mass of more than 1000 and a functionality of more than 2.0, in a fraction of at least 50% by weight based on a total amount of isocyanate-reactive substances used to form the chemically crosslinked polyurethane, where at least 80% by weight of other isocyanate-reactive starting materials used to form the chemically crosslinked polyurethane have a molar mass of less than or equal to 1000 and a nominal functionality of 2.0, and where a composition of the starting materials used to form the chemically crosslinked polyurethane is distinguished by a ratio of the number of isocyanate groups to the total number of isocyanate-reactive groups in said composition being between 0.8 and 1.2.

2. Double-sided pressure-sensitive adhesive according to claim 1, wherein the ratio is between 0.9 and 1.1.

3. Double-sided pressure-sensitive adhesive according to claim 2, wherein the ratio is between 0.95 and 1.05.

4. Double-sided pressure-sensitive adhesive tape according to claim 1, wherein the starting materials used to form the chemically crosslinked polyurethane comprise at least one polypropylene glycol having a molar mass of more than 1000 and a functionality of more than 2.0, in a fraction of at least 60% by weight based on a total amount of isocyanate-reactive substances.

5. Double-sided pressure-sensitive adhesive tape according to claim 4, wherein the fraction is at least 70% by weight based on the total amount of the isocyanate-reactive substances.

6. Double-sided pressure-sensitive adhesive tape comprising first and second sides which differ in adhesive strength, said first side comprising at least one adhesive layer comprising a pressure-sensitive adhesive based on a chemically crosslinked polyurethane, where the chemically crosslinked polyurethane is formed from starting materials comprising at least one polypropylene glycol having a molar mass of less than or equal to 1000 and a functionality of more than 2.0, whose hydroxyl groups have a fraction of at least 50% of a total number of isocyanate-reactive groups, where at least 80% of other isocyanate-reactive groups of the starting materials used to form the chemically crosslinked polyurethane are carried by starting materials having a molar mass of more than 1000 and a nominal functionality of 2.0, and where a composition of the starting materials used to form the chemically crosslinked polyurethane is distinguished by a ratio of the number of isocyanate groups to the total number of isocyanate-reactive groups being between 0.8 and 1.2.

7. Double-sided pressure-sensitive adhesive tape according to claim 6, wherein the ratio is between 0.9 and 1.1.

8. Double-sided pressure-sensitive adhesive according to claim 7, wherein the ratio is between 0.95 and 1.05.

9. Double-sided pressure-sensitive adhesive tape according to claim 6, wherein the starting materials used to form the chemically crosslinked polyurethane comprise at least one polypropylene glycol having a molar mass of less than or equal to 1000 and a functionality of more than 2.0, whose hydroxyl groups have a fraction of at least 60% of the total number of the isocyanate-reactive groups.

10. Double-sided pressure-sensitive adhesive tape according to claim 9, wherein the fraction is at least 70% of the total number of isocyanate-reactive groups.

11. Double-sided pressure-sensitive adhesive tape according to claim 1, which comprises first and second adhesive layers, and the first adhesive layer is formed of the polyurethane-based pressure-sensitive adhesive and has a lower bond strength than the second adhesive layer.

12. Double-sided pressure-sensitive adhesive tape according to claim 6, which comprises first and second adhesive layers, and the first adhesive layer is formed of the polyurethane-based pressure-sensitive adhesive and has a lower bond strength than the second adhesive layer.

13. Double-sided pressure-sensitive adhesive tape according to claim 1, which comprises three or more layers, with first and second adhesive layers being applied in opposition on a backing layer, the first adhesive layer being formed of the polyurethane-based pressure-sensitive adhesive.

14. Double-sided pressure-sensitive adhesive tape according to claim 6, which comprises three or more layers, with first and second adhesive layers being applied in opposition on a backing layer, the first adhesive layer being formed of the polyurethane-based pressure-sensitive adhesive.

15. Double-sided pressure-sensitive adhesive tape according to claim 1, wherein the pressure-sensitive adhesive is formed from a polyisocyanate that is an aliphatic or alicyclic diisocyanate.

16. Double-sided pressure-sensitive adhesive according to claim 15, wherein the polyisocyanate is an aliphatic or alicyclic diisocyanate of asymmetrical molecular structure.

17. Double-sided pressure-sensitive adhesive according to claim 16, wherein the polyisocyanate is isophorone diisocyanate (IPDI).

18. Double-sided pressure-sensitive adhesive tape according to claim 6, wherein the pressure-sensitive adhesive is formed from a polyisocyanate that is an aliphatic or alicyclic diisocyanate.

19. Double-sided pressure-sensitive adhesive according to claim 18, wherein the polyisocyanate is an aliphatic or alicyclic diisocyanate of asymmetrical molecular structure.

20. Double-sided pressure-sensitive adhesive according to claim 19, wherein the polyisocyanate is isophorone diisocyanate (IPDI).

21. Double-sided pressure-sensitive adhesive tape according to claim 1, wherein the pressure-sensitive adhesive is formed from an isocyanate-reactive substance that is a polyol.

22. Double-sided pressure-sensitive adhesive tape according to claim 21, wherein the polyol is selected from the group consisting of polyether-polyols and polyester-polyols.

23. Double-sided pressure-sensitive adhesive tape according to claim 6, wherein the pressure-sensitive adhesive is formed from an isocyanate-reactive substance that is a polyol.

24. Double-sided pressure-sensitive adhesive tape according to claim 23, wherein the polyol is selected from the group consisting of polyether-polyols and polyester-polyols.

25. Double-sided pressure-sensitive adhesive tape according to claim 1, which is in the form of punched or cut shapes.

26. Double-sided pressure-sensitive adhesive tape according to claim 6, which is in the form of punched or cut shapes.

27. Process for producing an adhesive tape according to claim 1, said process comprising the following steps:
(a) charging a vessel A substantially with premixed isocyanate-reactive substances (polyol component) and a vessel B substantially with the isocyanate component, any other formulating ingredients optionally being mixed into these components beforehand;
(b) conveying the polyol component and the isocyanate component via precision pumps through a mixing head or mixing tube of a multi-component mixing or metering unit, where they are homogeneously mixed and so brought to reaction to form a reactive polyurethane composition;
(c) coating the reactive polyurethane composition onto a backing material in web form which is provided with a second pressure-sensitive adhesive layer and which is optionally moving at constant speed;
(d) passing the backing material coated with the reactive polyurethane composition through a heating tunnel in which the polyurethane composition cures to the pressure-sensitive adhesive; and
(e) winding up the coated backing material in a winding station.

28. Process for producing an adhesive tape according to claim 6, said process comprising the following steps:
(a) charging a vessel A substantially with premixed isocyanate-reactive substances (polyol component) and a vessel B substantially with the isocyanate component, any other formulating ingredients optionally being mixed into these components beforehand;
(b) conveying the polyol component and the isocyanate component via precision pumps through a mixing head or mixing tube of a multi-component mixing or metering unit, where they are homogeneously mixed and so brought to reaction to form a reactive polyurethane composition;
(c) coating the reactive polyurethane composition onto a backing material in web form which is provided with a second pressure-sensitive adhesive layer and which is optionally moving at constant speed;
(d) passing the backing material coated with the reactive polyurethane composition through a heating tunnel in which the polyurethane composition cures to the pressure-sensitive adhesive; and
(e) winding up the coated backing material in a winding station.

29. A method comprising adhering flexible storage media to a curved, bent or creased surface with the double-sided pressure-sensitive adhesive tape according to claim 1.

30. Method according to claim 29, wherein the flexible storage media is selected from the group consisting of CDs, CD-ROMs and DVDs.

31. A method comprising adhering flexible storage media to a curved, bent or creased surface with the double-sided pressure-sensitive adhesive tape according to claim 6.

32. Method according to claim 31, wherein the flexible storage media is selected from the group consisting of CDs, CD-ROMs and DVDs.

33. A method comprising adhering a customer card or a credit card to a letter with the double-sided pressure-sensitive adhesive tape according to claim 1.

34. A method comprising adhering a customer card or a credit card to a letter with the double-sided pressure-sensitive adhesive tape according to claim 6.

35. A combination comprising a CD, CD-ROM, DVD, customer card or credit card and a double-sided adhesive tape according to claim 1.

36. A combination comprising a CD, CD-ROM, DVD, customer card or credit card and a double-sided adhesive tape according to claim 6.
